(19) United States
(12) Patent Application Publication
(10) Pub. No.: US 2002/0184269 A1
(43) Pub. Date: Dec. 5, 2002

(54) Document management systems for and methods of sharing documents

(76) Inventor: Satoshi Imagou, Kawasaki-shi (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/090,364

(22) Filed: Mar. 4, 2002

(30) Foreign Application Priority Data
Mar. 29, 2001 (JP) 2001-095623
Mar. 14, 2001 (JP) 2001-071473

(51) Int. Cl. G06F 15/00

(52) U.S. Cl. 707/523

(57) ABSTRACT

The document management systems or modules generally have their unique requirements for the document formats and or the information that are stored for the management of documents. Because of the above requirements, the prior art document management systems or modules fail to exchange or share the documents. The document management systems and modules of the current invention overcome the above difficulties by converting the document data requirements from one system to another. The conversion includes a predetermined set of procedures where certain data is added, deleted or modified so that the documents are compatible among the document management systems, units or modules.

### FIELD OF THE INVENTION

The current invention is generally related to document management, and more particularly related to a system for and a software program for exchanging a predetermined types of document information between terminal devices.

### BACKGROUND OF THE INVENTION

Network systems have document management functions for processing documents information and exchanging documents between access terminals. In Japanese Patent Publication Hei 2000-99512, one exemplary document management method includes the conversion of a document format that has been formatted by a known word processor into an internally common format as well as the extraction of partial structures that are needed by a predetermined processing application. The above example is implemented by using an available language such as Extended Mark-up Language (XML), and the tags that are actually used depend upon an original document. By preparing a set of rules for the internal structures of the documents, certain information such as a title and an index is extracted for subsequent document processing. Unfortunately, although the above described prior technology converts various document formats into a common format before extracting information, it fails to disclose any information or property that is attached to the documents for the purpose of managing the documents.

For the discussion of the above document property information, a second prior art technology discloses serialized documents in order to facilitate the exchange of the documents between document management servers or between a document management server and a document management client. Furthermore, the prior art technology has separately managed the property information and the document content. The document content includes document images that have been scanned by a scanner and document data that have been inputted through a word processing application program. In general, since the document contents have various formats, it appears difficult for a document management application program to take advantage of the content formats. The property information includes data such as a title and a file date that has been attached to the document file. A document management server specifies a predetermined set of properties. Based upon the specified property, it is easier for a document management application program to deal with the document files regardless of their contents that include text data, graphics data and audio data. Thus, in the above second prior art technology, a method is disclosed to use a property set as expressed in a serialized document by XML between document management servers or between a document management server and a document management client.

The above described second technology unfortunately fails when the document management servers are not identical. In other words, the structure of the serialized documents, a list of properties, corresponding property values and formats all depend upon the definitions of a particular document management server. For example, assuming that stream means document content, one document management server defines an internal document structure as “document version stream” while another management server defines the internal document structure as “document stream.” To further illustrate the discrepancies among the servers, one document management server allows a single stream in one document while another document server allows multiple streams in a single document.

The following specific situations remain as barriers to use the serialized documents in performing the document exchange. Firstly, when a transmission side does not manage property information that a reception side needs for processing a document, a serialized document lacks the necessary property information. Secondly, the reception side receives property values or document contents in a format that is different from that of the transmission side. Thirdly, the reception side receives the serialized documents in an internal structure that cannot be processed by the reception side. For example, the received serialized document contains version information which a document management server in the reception side does not maintain. Lastly, the reception side receives the serialized documents lacking an internal structure that is needed by the reception side. For example, the received serialized document fails to contain version information which a document management server in the reception side needs.

A third prior art technology in Japanese Patent Publication Hei 11-353307 discloses a method of converting document data in a directory into a Hyper Text Markup Language (HTML) while maintaining a hierarchical structure. One ultimate goal of the conversion is to publish the documents through a World Wide Web (WWW) server. The above hierarchical structure is a tree structure of file folders or directories. The internal structure of a document in the directory is not considered in the third prior art technology. A document management system generally includes a server for maintaining a database for documents and a client for accessing one of the documents via network and the server to process the document. In case of off-line access, a document is copied from the server to a mobile device in advance. To display the document in the terminal device, the document is converted into the HTML format. However, if the document is modified in the mobile device, the modified document cannot be stored back from the client terminal device to the document management server.

For the above described reasons, it is desirable to improve the document management by providing architecture for document exchange in information terminals so that documents are freely exchanged between servers regardless of property, data expressions and document models. The servers include not only document management servers but also a combination of a document management server and a regular file server without a document management software program.

### SUMMARY OF THE INVENTION

In order to solve the above and other problems, according to a first aspect of the current invention, a method of exchanging a document between at least two document management systems, including the steps of: placing at least a first document in a first predetermined serialized format at a first document management system to generate a serialized document; transferring the serialized document from the first document management system to a second document management system; receiving the serialized document at the second document management system; and converting the serialized document into a second predetermined format at the second document management system to generate a converted serialized document.

According to a second aspect of the current invention, a system for sharing a document between at least two document management units, including: a first document managing unit for placing at least a first document in a first predetermined serialized format to generate a serialized document, the first document managing unit transferring the serialized document to a second document management unit; and a second document managing unit operationally connected to the first document managing unit for receiving the serialized document and converting the serialized document into a second predetermined format to generate a converted serialized document.

According to a third aspect of the current invention, a storage medium for storing an interface program for document management modules, the interface program executing computer instructions to perform the following tasks of: placing at least a first document in a first predetermined serialized format at a first document management module to generate a serialized document; transferring the serialized document from the first document management module to a second document management module; receiving the serialized document at the second document management module; and converting the serialized document into a second predetermined format at the second document management module to generate a converted serialized document.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating one preferred embodiment of the document exchange system according to the current invention.

FIG. 2 is a flow chart illustrating steps involved in a preferred process of processing a serialized document according to the current invention.

FIG. 3 is a flow chart illustrating steps involved in a preferred process of processing a <ListOfProp> element according to the current invention.

FIG. 4 is a flow chart illustrating steps involved in a preferred process of processing a <ListOfContent> element according to the current invention.

FIG. 5 is a block diagram illustrating a preferred embodiment of the document search system according to the current invention.

FIG. 6 is a table containing exemplary data for documents.

FIG. 7 is a table containing exemplary version data.

FIG. 8 is a table containing exemplary URI data.

FIG. 9 is a table containing exemplary folder data.

FIG. 10 illustrates the content of a serialized document that includes the above exemplary information from the tables in FIGS. 6 through 9.

FIG. 11 is a diagram illustrating a structure in which the serialized document filing unit has generated directories and files based upon the exemplary serialized document as shown in FIG. 10.

FIG. 12 is a flow chart illustrating general steps involved in a preferred process of generating files and directories according to the current invention.

FIG. 13 is a flow chart illustrating detailed steps involved in a preferred process of converting nodes or the above step S3 according to the current invention.

FIG. 14 is a flow chart illustrating general steps involved in a preferred process of serializing a document in a file system according to the current invention.

FIG. 15 is a flow chart illustrating detailed steps involved in a preferred process of converting the directories according to the current invention.

FIG. 16 is a diagram illustrating a preferred embodiment of the document management system according to the current invention.

### DETAILED DESCRIPTION OF THE PREFERRED EMBODIMENT(S)

In general, a preferred embodiment of the document exchange system according to the current invention manages documents for exchange among various information terminals and document management servers based upon a common architecture for a document conversion format. The information terminals and document management servers each perform a different set of document management functions. That is, the information terminals and document management servers use various types of property information, data expressions and document models. The preferred embodiment of the document transmission system according to the current invention properly manages document exchanges between the terminals and or the servers based upon the property that includes information on the document content, bibliographical information and other information for processing the document.

To accomplish the above goal, information terminals perform transmission and reception functions. An information terminal on the document transmission side includes a serial conversion unit for generating a serialized document in a single stream that contain the document content and the property according to a predetermined format. Hereinafter, the serialized document necessarily contains both the document content and the property information. The serialized document is generated in a predetermined common data format such as XML from various types of data formats that are unique to information terminals. The information terminal on the document reception side includes a document management unit for managing the document content and the property information, a format conversion unit for converting the received data in the predetermined format to another format that the document management unit utilizes and a serialized data dividing unit for dividing the converted serialized data into elements for the document content and the property information.

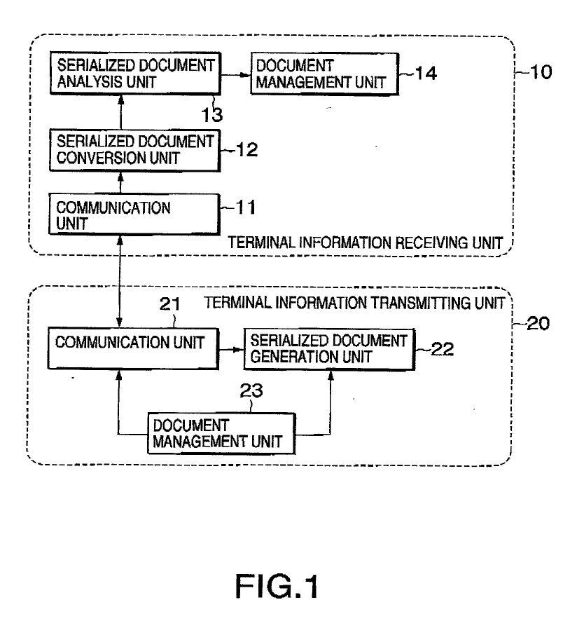

Referring now to the drawings, wherein like reference numerals designate corresponding structures throughout the views, and referring in particular to FIG. 1, a block diagram illustrates one preferred embodiment of the document exchange system according to the current invention. The preferred embodiment includes an information terminal 10 at a transmission side as well as an information terminal 20 at a reception side.

Although the following description provides only transmission flnctions for the information terminal 10 and only reception functions for the information terminal 20, the information terminals 10 and 20 generally have both the transmission and reception functions. The transmission informational terminal 20 and the reception information terminal 10 also finction as a server for transmitting document data and a client for receiving the transmitted document data. The preferred embodiment of the document exchange system according to the current invention is implemented using an existing personal computer (PC), which runs software as a part in a desk-top-like application for providing document management finctions as well as offering and retrieving information through a network such as the Internet.

Still referring to FIG. 1, the elements or components of the information terminals 10 and 20 will be described. The transmission information terminal 20 further includes a transmission or communication unit 21, a serialized document generation unit 22 and a document management unit 23. The simplest implementation of the document management unit 23 manages two layers of information including a first layer for the document information and a second layer for streams. For example, a relational data base is maintained to manage the document information such as document IDs, document names, creation dates and authors as well as streams such as stream IDs, corresponding document IDs and corresponding document data. When version information is contained in the document, the document management unit 23 manages three layers of information including a first layer for the document information, a second layer for versions and a third layer for streams. For example, a relational data base is maintained to manage the document information such as document IDs, document names, creation dates and authors, version information such as version IDs, corresponding document IDs, version numbers and revised dates and streams such as stream IDs, corresponding version IDs and URI.

The serialize document generation unit 22 processes the document content and the property information in a serial format. As described above, the management unit 23 maintains a relational database for maintaining the document content and the associated property information in a certain format. Assuming that a plurality of the transmission information terminals each supports a unique format for the document content data and the property information and that a reception information terminal supports the multiple transmission information terminals, the reception information terminal must perform a correspondingly unique process upon receiving the document content data and the property information. Furthermore, when the data is sent in a binary format, different central processing units (CPU) at a transmission side and a reception are not compatible for processing the identical binary format data. For this and other reasons, the document data is sent in a predetermined format from the transmission side to the reception side. The serialization process thus involves the conversion of the data in an internal format in the document management unit 23 at the transmission side to the text data in the above predetermined format. The text data is expressed in XML for subsequent processing by programs. XML is defmed in “Extensive Markup Language (XML) 1.0 W3C Recommendation, 1998/2/10.”

One example of serializing straightforward document is illustrated below:

<Document>

<ListOfProp>

<Prop Name=“Title”>Example Document</Prop>
<Prop Name=“Date”>January 1, 2002</Prop>
<Prop Name=“Creator”>John Simith</Prop>

</ListOfProp>
<ListOfContent>

<Document Type=“Primitive”>

<ListOfProp></ListOfProp>
<Content Uri =“http://foo/bar1” Method=“GET”/>

</Document>
<Document Type=“Primitive”>

<ListOfProp></ListOfProp>
<Content Uri=“http://foo/bar2” Method=“GET”/>

</Document>

</ListOfContent>

</Document>

In the above example, a portion between <Document> and </Document> expresses the document. The document is hierarchical and contains parts of the document. In other words, within a part that is delimited by one pair of <Document> and </Document>, there is another part of the document that is also delimited by another pair of <Document> and </Document>. Similarly, a portion between <ListOfProp> and </ListOfProp> is a property list of the document. Each property has a document title as expressed in <PropName=“Title”>, where “Title” is a value of the document title. In the above example, another portion between <ListOfContent> and </ListOfContent> is a list of the document content. The document content include zero or more of sentence. A portion that starts with <Document Type =“Primitive”> is not content itself, but is information to access the document or the content itself as a content list. The next sentence, Uri =“http://foo/barl” Method=“GET”/> indicates that the content is obtained by accessing http://foo./barl according to a Get Method of HTTP.

The following is another example that is more sophisticated than the above example of the serialized document.

<Document>

<ListOfProp>

Example Document </Prop>

<Prop Name=“Date”>January 11, 2002</Prop>
<Prop Name=“Creator”>John Simith</Prop>

</ListOfProp>
<ListOfContent>

<Document Type=“Version”>

<ListOfProp>

<Prop Name=“Title”>1.2</Prop>
<Prop Name=“Date”>January 5, 2002</Prop>

</ListOfProp>
<ListOfContent>

<Document Type=“Primitive”>

<ListOfProp></ListOfProp>
<Content Uri=“http://foo/bar2-1” Method=
“Get”/>

</Document>

</ListOfContent>

</Document>
<Document Type=“Version”>

<ListOfProp>

<Prop Name=“Title”>1.1</Prop>
<Prop Name=“Date”>January 1, 2002 </Prop>

</ListOfProp>
<ListOfContent>

<Document Type=“Primitive”>

<ListOfProp></ListOfProp>
<Content Uri=“http://foo/bar1-1” Method=
“GET”/>

</Document)

</ListOfContent>

</Document>

</ListOfContent>

The above example includes a statement for versions, and with in each of the versions, the corresponding document content is inserted.

To serialize documents, the serialized document generation unit 22 extracts necessary information from the document that is specified by ID via the document management unit 23 and generates a serialized document based upon the extracted information. To generate the serialized documents, the serialized document generation unit 22 maintains a schema corresponding chart that provides relationship information. An exemplary schema corresponding chart is shown below.

Document Table

Property

Title: Document Name

Date: Document Creation Date

Creator: Author Name

Table Name for Content: Version Table

Version Table

Property

Title: Version Number

Date: Revision Date

Table Name for Content: Stream Table

Stream Table

The transmission unit 21 in the transmission information terminal 20 communicates with the reception information terminal 10. For example, the above communication includes a corresponding document via the document management unit 23 in response to a GET request from the reception information terminal 10 so that the transmission information terminal 20 has a HTTP server function. The above communication further includes a return of the serialized document to the reception information terminal 10. The reception information terminal 10 issues a document ID with respect to the GET request, and the document management unit 23 extracts all the predetermined information from the document that is specified by the document ID. The serialized document generation unit 22 converts the extracted information into a predetermined format of text, and the communication unit 21 returns the above serialized document to the reception information terminal 10.

The reception information terminal 10 further includes a reception or communication unit 11, a serialized document conversion unit 12, a serialized document analysis unit 13 and a document management unit 14. The reception information terminal 10 receives the serialized document data from the transmission information terminal 20, and the serialized document conversion unit 12 converts the serialized document data into the database format of the document management unit 14 as much as possible so that the document content data and the property data are acceptable to the document management unit 14. In certain situations, the serialized document data from the transmission information terminal 20 includes some information that is unique to the transmission information terminal 20 and or lacks other information that is needed by the reception information terminal 10. Before storing the serialized document data in a database in the document management unit 14, the serialized document conversion unit 12 converts the serialized document data format into a serialized format that is compatible with the reception information terminal 10 while minimizing the conversion to retain the original serialized format. It goes without saying that if the serialized format at the transmission terminal 20 is identical to the format at the reception terminal 10, the above described conversion is not necessary. Assuming that the serialized document data is expressed by XML, the conversion process is also express by XML.

The conversion process at the serialized document conversion unit 12 includes the following types of objectives:

1) the removal of unknown property information

2) the addition of necessary property information

3) the conversion of the property information value

4) the addition of necessary property elements

5) the partial removal of unknown elements

6) the complete removal of unknown elements The above enumerated sub-processes will be described in more details.

The removal process of unknown property information removes certain property information from the serialized document. As illustrated in the following example, the reception terminal 10 cannot process the property information, “Category” in the upper serialized document data and removes it to generate the serialized document data below an arrow.

<ListOfProp>

<Prop Name=“Title”>Document Name</Prop>
<Prop Name=“Category”>1234</Prop>

</ListOfProp>

↓

<ListOfProp>

<Prop Name=“Title”>Document Name</Prop>

</ListOfProp>

The addition process of unknown property information adds certain property information that is needed by the reception information terminal 10 to the serialized document. As illustrated in the following example, the reception terminal 10 needs the property information, “DocType” that is not included in the upper serialized document data and adds it to generate the serialized document data below an arrow. Since “DocType” needs a default value, the value, “Basic” is added in the example.

<ListOfProp>

<Prop Name=“Title”>Document Name</Prop>

<ListOfProp>

↓

<ListOfProp>

<Prop Name=“Title”>Document Name</Prop>
<Prop Name=“DocType”>Basic<Prop>

The conversion of property values converts property values to a predetermined range and format when the original property values are not within the range or format. The conversion also includes the format conversion of image and audio data even if they are in a predetermined property value range. The predetermined set of formats is specified as predetermined values. The conversion further includes the document content as a type of property value conversions. As illustrated in the following example, “Date” in the upper serialized document data has a value of a property format that is different from that of the reception information terminal 10, and the value is converted to generate the serialized document data below an arrow.

ListOfProp>

<Prop Name=“Date”>2000-12-10T15:30+0900</Prop>

<ListOfProp>

↓

<ListOfProp>

<Prop Name=“Date”>20001210T0630Z</Prop>

<ListOfProp>

The addition of necessary elements adds a default version information to a serialized document when the serialized document lacks the version information that the reception information terminal 10 needs. As illustrated in the following example, “Version” in Document Type is added to the upper serialized document data to generate the serialized document data below an arrow. Version in Document Type also needs ListOfProp, which is also added to the new serialized document.

<Document>

<ListOfProp>

<Prop Name=“Title”>Document Name</Prop>
<Prop Name=“Date”>2000-1-3</Prop>

</ListOfProp>
<ListOfContent>

<Document Type=“Primitive”>

<Content Uri=“http://foo/bar2-1” Method=“GET”/>

</Document>

</ListOfContent>

</Document>

↓

<Document>

<ListOfProp>

<Prop Name=“Title”>Document Name</Prop>

</ListOfProp>
<ListOfContent>

<Document Type=“Version”>

<ListOfProp>

<Prop Name=“VersionNo”>1</Prop>

<Prop Name“VersionUpdate”>2000-1-3</Prop>

</ListOfProp>
<ListOfContent>

<Document Type=“Primitive”>

<Content Uri=“http://foo/bar2-1” Method=
“GET”/>

</Document>

</ListOfContent>

</Document>

</ListOfContent>

</Document>

The partial removal of some unknown elements removes an element when the reception removal unit 10 cannot process the element. For example, the partial element removal process is a reverse of the above example by removing “Version” in Document Type while leaving other elements that the reception information terminal 10 is capable of processing.

The complete removal of all unknown elements removes an element and its associated internal elements when the reception removal unit 10 cannot process the element. For example, assuming that the reception information terminal 10 manages a single stream for each document and receives a serialized document with a plurality of streams, the second <Document> and its associated elements are completely removed from the upper serialized document data in the lower serialized document.

<Document>

<ListOfProp>

<Prop Name=“Title”>Document Name</Prop>
<Prop Name=“Date”>2000-1-3</Prop>

</ListOfProp>
<ListOfContent>

<Document Type=“Primitive”>

<Content Uri=“http://foo/bar2-1” Method=“GET”/>

</Document>
<Document Type=“Primitive”>

<Content Uri=“http://foo/bar2-2” Method=“GET”/>

</Document>

</ListOfContent>

</Document>

↓

<Document>

<ListOfContent>

<Prop Name=“Title”>Document Name</Prop>

<Prop Name=“Date”>2000-1-3</Prop>

</ListOfProp>

<ListOfContent>

<Document Type=“Primitive”>

<Content Uri=“http://foo/bar2-1” Method=“GET”/>

</Document>

</ListOfContent>

</Document>

Still referring to FIG. 1, the reception information terminal includes the serialized document analysis unit 13 and the document management unit 14. The serialized document analysis unit 13 receives the serialized document that has been converted to a format according to the reception information terminal 10 by the serialized document conversion unit 12. The serialized document analysis unit 13 breaks the serialized document into internal expressions. For example, the inter expressions are tree structures having nodes containing sentences, and each of the nodes has property information for characteristics. Based upon the above property information in the serialized document, the document management unit 14 manages the document and property data by inserting values in the corresponding fields of the tables in the database. Alternatively, instead of storing in the database, a document processing application program processes property information.

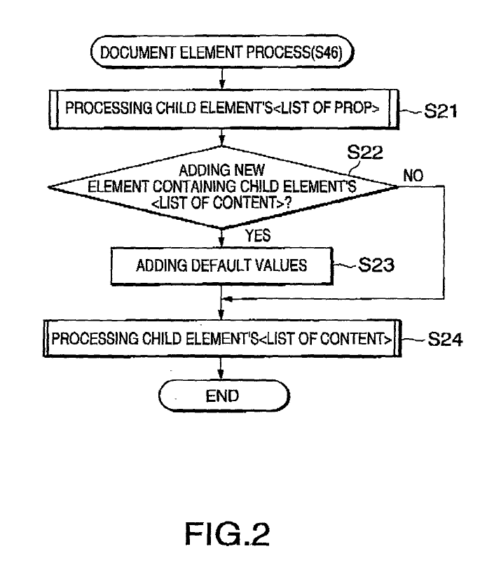

Now referring to FIG. 2, a flow chart illustrates steps involved in a preferred process of processing a serialized document according to the current invention. In general, the flow chart illustrates a main routine in which the serialized document conversion unit 12 performs the following operations on the received serialized document data that is expressed in XML. In a step S21, the serialized document conversion unit 12 processes a <ListOfProp> element which is a child of a <Document> element in the serialized document data. In a step S22, it is determined whether or not it is necessary to add a new element should be added. The new element is contained in a child <ListOfContent> element. If it is determined that the new element should be added in the step S22, the element is set to have a predetermined default value and the new element is added in a step S23. On the other hand, if it is determined that the new element should not be added in the step S22, the preferred process proceeds to a step S24 without performing the step S23. Subsequently, a <ListOfContent> element that is also a child of a <Document> element is processed in the step S24.

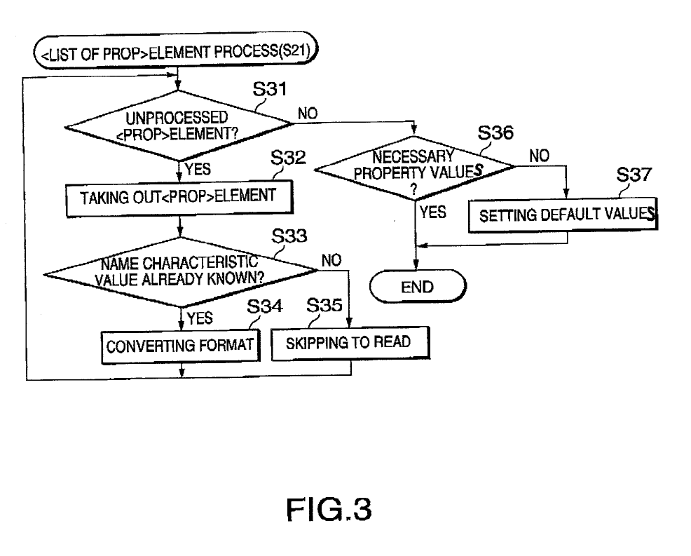

Now referring to FIG. 3, a flow chart illustrates steps involved in a preferred process of processing a <ListOfProp> element or the step S21 according to the current invention. In a step S31, it is determined whether or not an unprocessed <Prop> element exists. If it is determined that an unprocessed <Prop> element exists in the step S31, the unprocessed <Prop> element is taken out in a step S32. It is further determined whether or not the characteristic value of <Prop Name=““> in the above <Prop> element is already known in a step S33. If the characteristic value of <Prop Name=““> is known but its format is not compatible with the one of the reception unit, the characteristic value is converted into a predetermined format in a step S34. For the detailed implementation of the above conversion, refer to the above discussion of the conversion of the property values. On the other hand, the characteristic value of <Prop Name=““> is not known in a step S33, the characteristic value is skipped or ignored. Subsequent to the steps 33 and or 34, the preferred process proceeds back to the step S31 to further process unprocessed <Prop> elements.

Still referring to FIG. 3, if it is determined that an unprocessed <Prop> element fails to exist in the step S31, it is further determined whether or not necessary property values are available in a step S36. If necessary property values are not yet provided, predetermined default values are provided in a step S37 as described in the above 2) addition process of necessary property information. The preferred process terminates the current subroutine of processing the <ListOfProp> element. On the other hand, if necessary property values are already provided, the preferred process immediately terminates the current subroutine of processing the <ListOfProp> element.

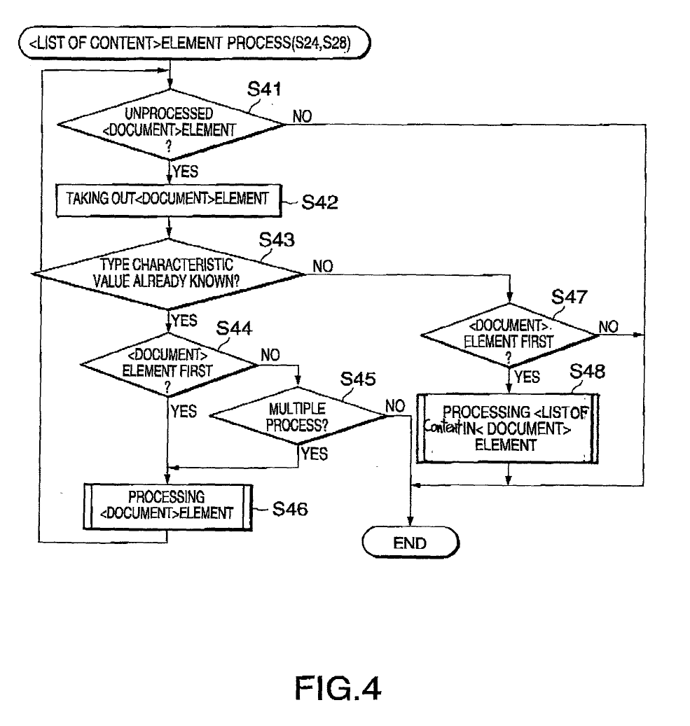

Now referring to FIG. 4, a flow chart illustrates steps involved in a preferred process of processing a <ListOfContent> element or the step S24 or S48 according to the current invention. In a step S41, it is determined whether or not an unprocessed <Document> element exists. If it is determined that an unprocessed <Document> element no longer exists in the step S41, the preferred process terminates the current subroutine. If it is determined that an unprocessed <Document> element exists in the step S41, the unprocessed <Document> element is taken out in a step S42. It is further determined whether or not the characteristic value of <Document Type=““>in the above <Document> element is already known in a step S43. If the characteristic value of <Document Type=““> is known, it is flurther determined whether or not the <Document> element is a first one in a step S44. If it is determined that the <Document> element is indeed the first element, the <Document> element is processed in a step S46. After the step S46, the preferred process proceeds to the step S41 to repeat the above described steps. On the other hand, if it is determined that the <Document> element is not the first element, a step S45 determines whether or not an appropriate process is performed for the non-first element. If a proper process is performed, the preferred process proceeds to the step S46. On the other hand, if no proper process is performed, the preferred process terminates the current subroutine after the above 6) complete removal process of unknown elements.

Still referring to FIG. 4, if the characteristic value of <Document Type=““> is not known, it is further determined whether or not the <Document> element is a first one in the step S47. If it is determined that the <Document> element is indeed the first element in the step S47, a <ListOfContent> element of the <Document> element is processed in a step S48. The preferred process terminates the current subroutine as described in the above 5) partial removal process of unknown elements. On the other hand, if it is determined that the <Document> element is not the first element in the step S47, the preferred process terminates the current subroutine.

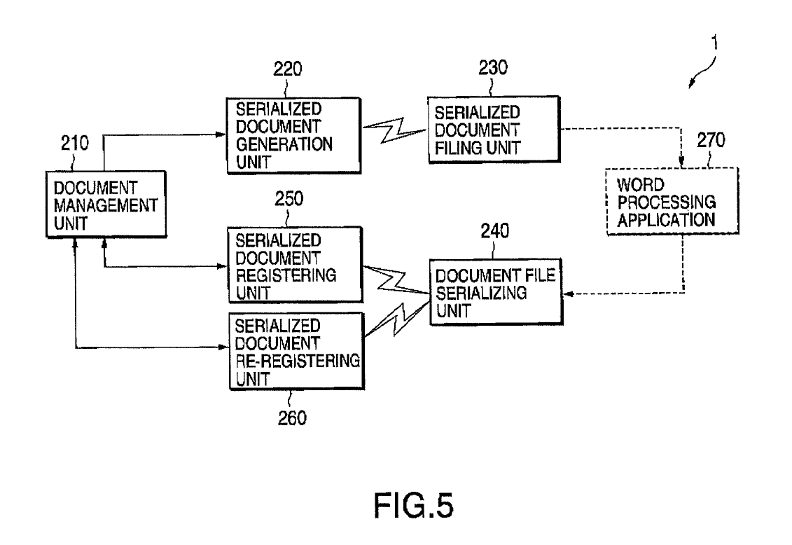

Now referring to FIG. 5, a block diagram illustrates a preferred embodiment of the document search system according to the current invention. In general, the document search system includes a document management server and a client that is connected to the document management server. The document management server manages documents information that includes document contents and the associated information such as document property and folders. The document information is managed in a layer structure. The layer structure means that a document is stored in a terminal node of a tree structure. The layer structure also means that a version number and an element file are internally stored in the document. As will be described, either a document or a folder is searched in the above layered structure. Upon searching a target, the searched document itself or the document in the searched folder will be converted.

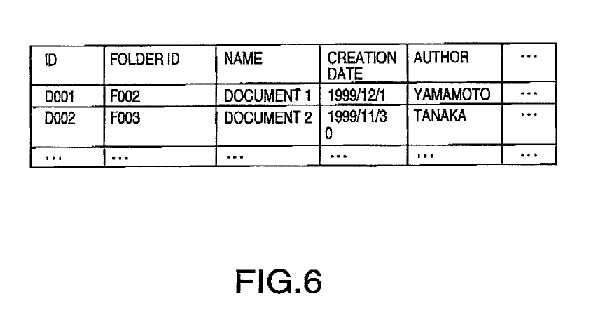

Still referring to FIG. 5, the preferred embodiment includes a document management unit 210, a serialized document generation unit 220, a serialized document filing unit 230, a document file serializing unit 240, a serialized document registering unit 250, a serializing document re-registering unit 260 and a word processing application program 270. The document management unit 210 manages document information including an internal version number. The document information has three layers of the information on versions, streams and documents. The document is generally placed in a folder, and the folders are organized in a tree structure. Except for a top node, a folder usually has a parent folder. The above described information is managed in a relational database. The document management unit 210 extracts necessary information from a folder or a document, and the serialized document generation unit 220 generates a serialized document based upon the extracted information. Since a binary data format requires an exact design and lacks expandability, the document information is transmitted in a predetermined text format. The conversion of an internal format in the document management unit 210 to the above described predetermined text format is considered as serialization of the document. To accomplish the above serialization, Extendible Markup Language (XML) is used to express data rather than plain text data. Based upon the serialized document, the serialized document filing unit 230 generates directories and files in the file system. Contrary to the serialized document filing unit 230, the document file serializing unit 240 serializes multiple document files in the file system. To further illustrate a process of generating the serialized document, the following exemplary data is shown in tables in FIGS. 6 through 9.

After the document file contents are serialized, the serialized document registering unit 250 and the serializing document re-registering unit 260 store or register the serialized document. Since the ID in the serialized document is likely used in the existing documents, a new ID should be allocated. For each of the <ID> elements, an unused new ID is allocated and stored in an ID conversion table. That is, for each of the <Folder>, <Document>, <Version> and <Stream> elements, necessary property information is extracted from a child element <ListOfProp> for generating a record. The newly generated record is inserted into a corresponding table. The ID property value is converted into a new unused value based upon an ID conversion table. The serializing document re-registering unit 260 updates a corresponding original document according to the serialized document. To update, the ID in the serialized document is used as a key for searching a record in a database, and the searched record is updated. That is, for each of the <Folder>, <Document>, <Version> and <Stream> elements, a property ID value is extracted from a child <ListOfProp> element, and the extracted ID value is used as a key for searching a corresponding record. The field value in the searched record is assigned to a corresponding property value from the child <ListOfprop> element.

Still referring to FIG. 5, to accommodate any property information and the elements, the serialized document filing unit 230, the serialized document registering unit 250 and the serializing document re-registering unit 260 perform the following functions as already described above with respect to another preferred embodiment.

1) the removal of unknown property information

2) the addition of necessary property information

3) the conversion of the property information value

4) the addition of necessary property elements

5) the partial removal of unknown elements

6) the complete removal of unknown elements

FIG. 6 is a table containing exemplary data for documents. ID is identification for a document while Folder ID is identification for a folder to which the document belongs. Name is a name of the document. Creation Date indicates a date the document has been generated, and Author is a name of an author who created the document. For example, a document whose ID is “D001” belongs to a folder whose folder ID is “F002.” The document D001 has a document name, “Document 1,” and it has been created on Dec. 1, 1999 by Yamamoto.

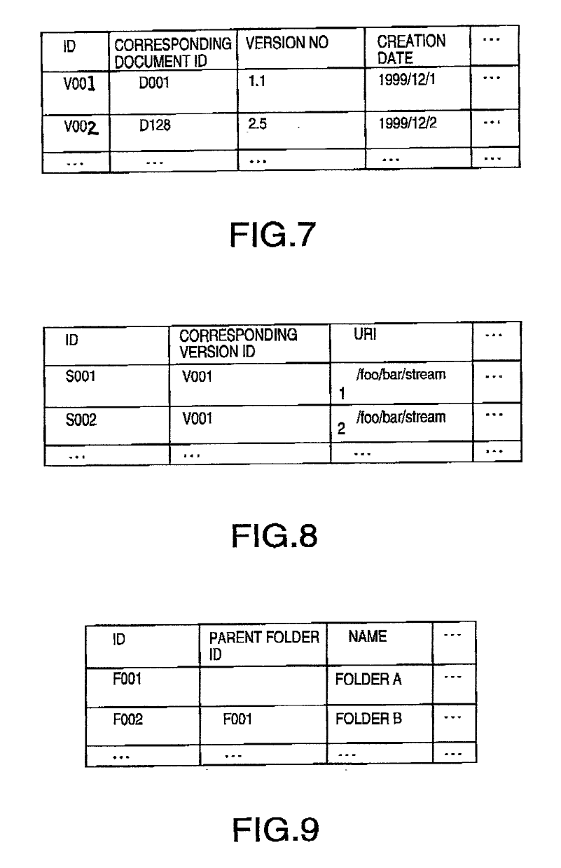

FIG. 7 is a table containing exemplary version data. ID is identification for a version for a document that is specified by a corresponding document ID, which corresponds to the document ID in FIG. 6. A version NO is a version number for each document that has been created on a date specified on Creation Date. For example, the document as specified by V001 has a corresponding document ID D001 and a version 1.1.

FIG. 8 is a table containing exemplary URI data. ID is identification for a URI for a document that is specified by a corresponding version ID, which corresponds to the version ID in FIG. 7. A version ID is a version ID for each document whose URI is specified in the table. For example, the document as specified by V001 has a corresponding URI, /foolbar/stream.

FIG. 9 is a table containing exemplary folder data. ID is identification of a folder, and Parent Folder ID is identification of a parent folder for the folder. For example, the folder F002 has a parent folder F001.

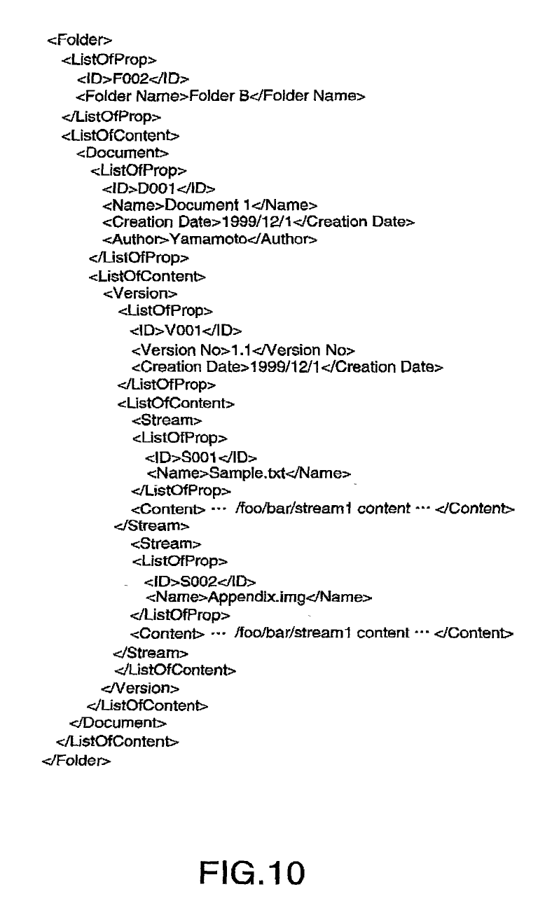

Based upon the above described exemplary data for the document in the folder F002 as shown in FIGS. 6 through 9, the serialized document generation unit 220 generates a serialized document. Now referring to FIG. 10, statements illustrate the content of the above exemplary serialized document that includes the information from the tables in FIGS. 6 through 9. A portion that is defined between <ListOfProp> and </ListOfProp> is a property list. The name for each of the tags in the property list comes from the fied name in the corresponding table. For example, the tags such as <ID>, <Name>, <Creation Date> and <Author> come from the filed names in the table in FIG. 6. A portion that is defined between <ListOfContent> and </ListOfContent> is an element in a next layer. If it is a folder, a next layer is either a folder of a document. Similarly, if it is a document, a next layer is a version, and if it is a version, a next layer is a stream. A portion between <Stream> and </Stream> includes a character row that encodes the content of the stream based upon Base 64.

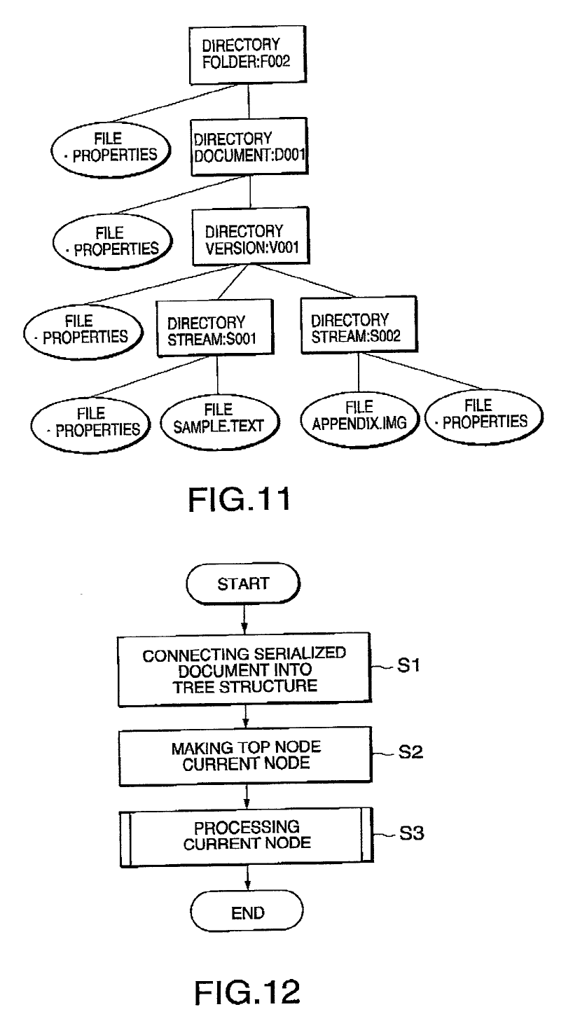

Now referring to FIG. 11, a diagram illustrates a structure in which the serialized document filing unit 230 has generated directories and files based upon the exemplary serialized document as shown in FIG. 10. Each of the generated directories and the generated files has a name. Each of the generated files belongs to a directory while each of the generated directories belongs to its parent directory except for a top directory, “Folder:F002.” The relationships among the generated directories in FIG. 11 corresponds those in the serialized document in FIG. 10.

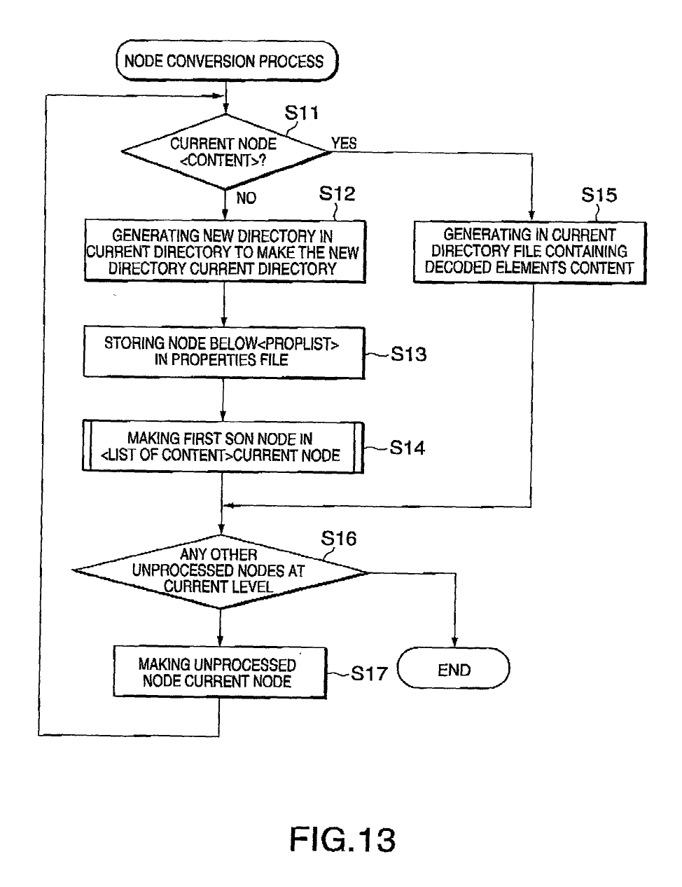

FIG. 12 is a flow chart illustrating general steps involved in a preferred process of generating files and directories according to the current invention. The serialized documents are converted into a tree structure in a step S1. After the conversion, a top node is made a current node in a step S2. The current node then goes through a node processing step in a step S3. The node processing step converts the nodes as will be explained in details with respect to FIG. 13.

Now referring to FIG. 13, a flow chart illustrates detailed steps involved in a preferred process of converting nodes or the above step S3 according to the current invention. In general, the <Folder>, <Document>, <Version> and <Stream> elements are corresponded to a folder or a directory while the <Content> elements are corresponded to a file. Similarly, the father-son relationships among the directories are corresponded to those among the elements in a serialized document. A name of a directory is generated from a combination of a corresponding element name and an <ID> property value. For example, if a folder has an ID having “F002,” the name of the folder becomes “Folder:F002.” A name of a file is generated from the <Name> property value of the <Stream> element. The property values of each element is stored in a predetermined name file. For example, the <ListOfProp> element is stored in a character row in a properties file. An application program has access to a relevant portion of the data stored in the above described data structure through the directories and the files. The stored data is also optionally updated after the access.

Still referring to FIG. 13, steps for the above described process are described in the following. It is determined in a step S11 whether or not a current node is <content> in the serialized document. If it is determnined in the step S11 that the current node is <content>, a new file is generated in the current directory to store decoded element contents. Subsequently, the preferred process proceeds to a step S16. On the other hand, if it is determined in the step S11 that the current node is not <content>, a new directory is generated in the current directory and the new directory becomes the current directory in a step S12. Furthermore, in a step S13, nodes below <ListOfProp> are stored in a properties file in XML. In a step S14, a first node in <ListOfContent> is now made as a current node. In a step S16, it is determined whether or not any node remains unprocessed or unconverted at the same level. If it is determined in the step S16 that there is an unprocessed node, the unprocessed node becomes the current node in a step S17, and the preferred process proceeds to the step S11 to repeat the above described steps S11 through S17. On the other hand, if it is determined in the step S16 that there is not any unprocessed node, the preferred process terminates itself.

Still referring to FIG. 13, the preferred process takes one of the following two paths. If either one of the <Folder>, <Document> and <Version> nodes is generated in the step S35, S36 or S37, the preferred process proceeds to a step S39, where a properties file directly under the corresponding node is read and a <ListOfProperty> node is generated. Furthermore, in a step S40, a <ListOfContent> node is generated. After the above described nodes have been generated, a first child of the current directory becomes a new current directory in a step S41. On the other hand, if the <Stream> node is generated in the step S38, the properties file directly under the corresponding node is read and a <ListOfProperty> node is generated in a step S42. In a step S43, the properties file not directly under the corresponding node is read and a <Content> node is generated. After completing the above described steps in either of the two paths, the preferred process in a step S44 determines whether or not any unprocessed directory exists at the current level. If it is determined in the step S44 that any unprocessed directory exists, the preferred process proceeds back to the step 31 to repeat the above described steps after the unprocessed directory becomes a new current directory in a step S45. On the other hand, it is determined in the step S44 that no unprocessed directory exists, the preferred process terminates.

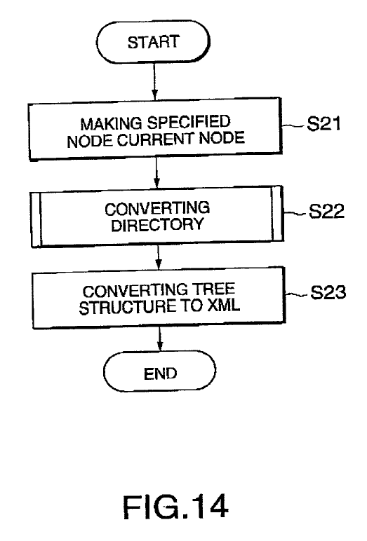

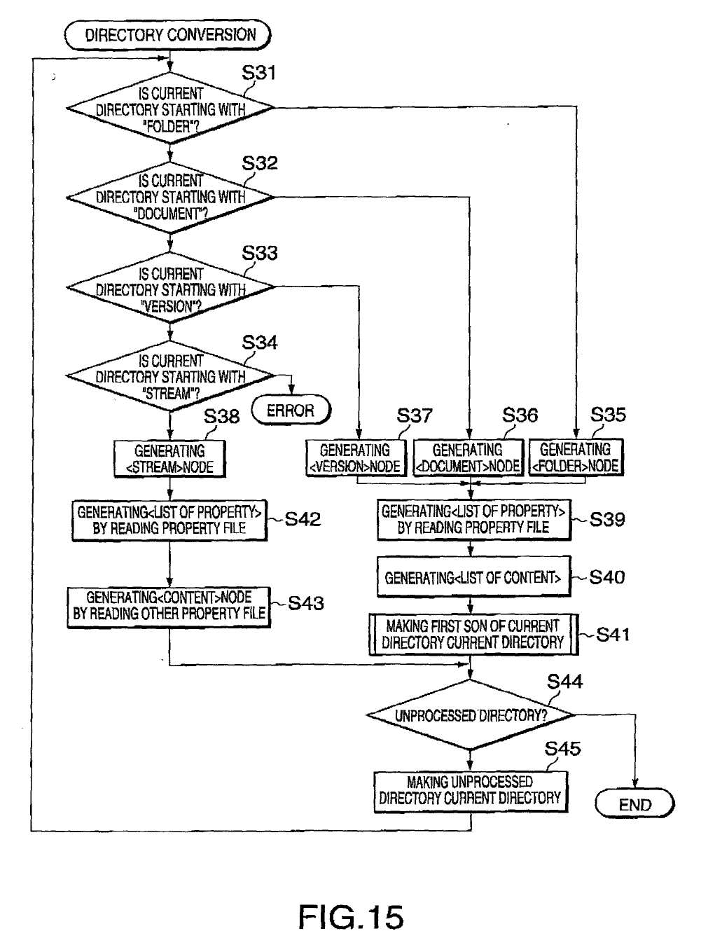

FIG. 14 is a flow chart illustrating general steps involved in a preferred process of serializing a document in a file system according to the current invention. In general, since the directory name starts with either “Folder,” “Document,” “Version” or “Stream,” the directory corresponds a certain element in the serialized document. On the other hand, a file corresponds to the <content> element of the serialized document. The name of the file corresponds to the name property of the <Stream> or parent element. The general steps of serializing a document in a file system involve the following. In a step S21, a specified directory becomes the current directory. In a step S22, the current directory is converted or processed. After the conversion in the step S22, the internal tree structure is converted into XML in a step S23. The detailed steps of the conversion step S22 will be described with respect to FIG. 15.

Now referring to FIG. 15, a flow chart illustrates detailed steps involved in a preferred process of converting the directories or the above step S22 according to the current invention. It is determined in a step S31 whether or not the current directory name begins with “Folder.” If it is determined in the step S31 that the current directory name begins with “Folder,” a <Folder> node is generated in a step S35. On the other hand, if it is determined in the step S31 that the current directory name fails to begin with “Folder,” it is further determined whether or not the current directory name begins with “Document” in a step S32. If it is determined in the step S32 that the current directory name begins with “Document,” a <Document> node is generated in a step S36. On the other hand, if it is determined in the step S21 that the current directory name fails to begin with “Document,” it is further determined whether or not the current directory name begins with “Version” in a step S33. If it is determined in the step S33 that the current directory name begins with “Version,” a <Version> node is generated in a step S37. On the other hand, if it is determined in the step S33 that the current directory name fails to begin with “Version,” it is further determined whether or not the current directory name begins with “Stream” in a step S34. If it is determined in the step S34 that the current directory name begins with “Stream,” a <Sream> node is generated in a step S38. On the other hand, if it is determined in the step S34 that the current directory name fails to begin with “Stream,” the preferred process terminates.

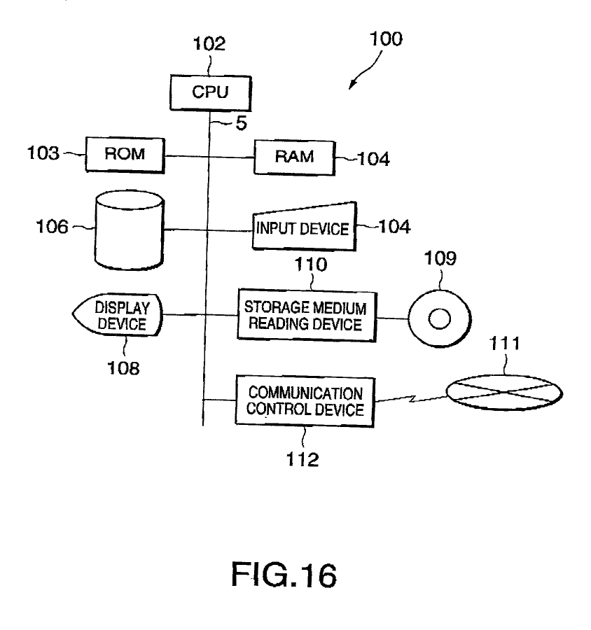

Now referring to FIG. 16, a diagram illustrates a preferred embodiment of the document management system according to the current invention. The document management system 100 includes a central processing unit (CPU) 102 for controlling various units via a predetermined software program, a Read Only Memory (ROM) 103 for storing software such as BIOS, a Random Access Memory (RAM) 104 for providing a working memory area and a bus 105 for connecting the above units. In addition, the bus 105 connects a hard disk storage unit 106, an input device 107 such as a keyboard and a mouse, a display device 108 such as a cathode ray tube (CRT) and a liquid crystal display (LCD), a storage medium reading device 110 for writing and reading information to and from a storage medium 109 such as CD, DVD and FD, and a communication control device 112 for communicating with a network 111. For example, the hard disk storage unit 106 stores a software program or computer instructions for implementing the document management according to the current invention. The storage medium reading device 110 reads the software program from the storage medium or the hard disk storage unit 106. The software program is optionally downloaded into the hard disk storage unit 106 via the Internet for installation. The above described software program for document management is optionally a part of a predetermined application program or a predetermined operating system that includes other functions. A client implements the document management functions of the serialized document generation unit 220, the serialized document filing unit 230, the document file serializing unit 240, the serialized document registering unit 250 and the serializing document re-registering unit 260 via the above described document management software program.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of exchanging a document between at least two document management systems, comprising the steps of:
placing at least a first document in a first predetermined serialized format at a first document management system to generate a serialized document;
transferring the serialized document from the first document management system to a second document management system;
receiving the serialized document at the second document management system; and
converting the serialized document into a second predetermined format at the second document management system to generate a converted serialized document.

2. The method of exchanging a document between at least two document management systems according to claim 1 wherein the first predetermined serialized format includes first document content and first property information, the second predetermined serialized format including second document content and second property information.

3. The method of exchanging a document between at least two document management systems according to claim 2 wherein said converting step further includes an additional step of adding a new piece of property information to the first property information according to the second property information.

4. The method of exchanging a document between at least two document management systems according to claim 2 wherein said converting step further includes an additional step of deleting a piece of property information from the first property information according to the second property information.

5. The method of exchanging a document between at least two document management systems according to claim 2 wherein said converting step farther includes an additional step of converting a piece of the first property information to a corresponding piece of the second property information.

6. The method of exchanging a document between at least two document management systems according to claim 1 further comprising additional steps of:
breaking the converted serialized document into a predetermined set of document units at the second document management system; and
storing the document units at the second document management system.

7. The method of exchanging a document between at least two document management systems according to claim 1 wherein the first document management system and the second document management system are both a database manager.

8. The method of exchanging a document between at least two document management systems according to claim 1 wherein the serialized document includes a plurality of documents.

9. The method of exchanging a document between at least two document management systems according to claim 1 wherein the serialized document includes property information.

10. The method of exchanging a document between at least two document management systems according to claim 9 wherein the property information includes information on a title, a creation date, an author, a version and a stream as elements, each of the elements including a predetermined set of property values.

11. The method of exchanging a document between at least two document management systems according to claim 1 wherein the first document management system includes a first database manager for managing the first document and the second document management system includes a second database manager for managing the converted serialized document.

12. The method of exchanging a document between at least two document management systems according to claim 1 wherein the second document management system includes a database manager while the first document management system includes a file system for managing the first document in files and directories.

13. The method of exchanging a document between at least two document management systems according to claim 12 wherein the first document is represented by a predetermined set of the directories and the files, said placing step further comprising an additional step of generating the serialized document based upon the directories and the files of the first document.

14. The method of exchanging a document between at least two document management systems according to claim 1 wherein the first document management system includes a database manager while the second document management system includes a file system for managing the first document in files and directories.

15. The method of exchanging a document between at least two document management systems according to claim 14 wherein said converting step further comprising an additional step of generating the files and the directories based upon the serialized document to represent the first document in the second document management system.

16. The method of exchanging a document between at least two document management systems according to claim 15 wherein the first predetermined serialized format includes first document content and first property information, the second predetermined serialized format including second document content and second property information.

17. The method of exchanging a document between at least two document management systems according to claim 16 wherein said converting step further includes an additional step of adding a new piece of property information to the first property information according to the second property information.

18. The method of exchanging a document between at least two document management systems according to claim 16 wherein said converting step further includes an additional step of deleting a piece of property information from the first property information according to the second property information.

19. The method of exchanging a document between at least two document management systems according to claim 16 wherein said converting step further includes an additional step of converting a piece of the first property information to a corresponding piece of the second property information.

20. A system for sharing a document between at least two document management units, comprising:
a first document management unit for managing a first document;
a serialized document generation unit connected to said first document management unit for placing the first document in a first predetermined serialized format to generate a serialized document;
a first communication unit connected to said serialized document generation unit for transferring the serialized document;
a second communication unit connected to said first communication unit for receiving the serialized document;
a serialized document conversion unit connected to said second communication unit for converting the serialized document into a second predetermined format to generate a converted serialized document; and
a second document management unit operationally connected to said serialized document conversion unit for managing the converted serialized document.

21. The system for sharing a document between at least two document management units according to claim 20 wherein the first predetermined serialized format includes first document content and first property information, the second predetermined serialized format including second document content and second property information.

22. The system for sharing a document between at least two document management units according to claim 21 wherein said serialized document conversion unit adding a new piece of property information to the first property information according to the second property information.

23. The system for sharing a document between at least two document management units according to claim 21 wherein said serialized document conversion unit deleting a piece of property information from the first property information according to the second property information.

24. The system for sharing a document between at least two document management units according to claim 21 wherein said serialized document conversion unit converting a piece of the first property information to a corresponding piece of the second property information.

25. The system for sharing a document between at least two document management units according to claim 20 wherein said second document management unit further comprises a serialized document analysis unit for breaking the converted serialized document into a predetermined set of document units and a database manager for storing the document units.

26. The system for sharing a document between at least two document management units according to claim 20 wherein said first document management unit and said second document management unit each include a database manager.

27. The system for sharing a document between at least two document management units according to claim 20 wherein the serialized document includes a plurality of documents.

28. The system for sharing a document between at least two document management units according to claim 20 wherein the serialized document includes property information.

29. The system for sharing a document between at least two document management units according to claim 28 wherein the property information includes information on a title, a creation date, an author, a version and a stream as elements, each of the elements including a predetermined set of property values.

30. The system for sharing a document between at least two document management units according to claim 20 wherein the first document management unit includes a first database manager for managing the first document and the second document management unit includes a second database manager for managing the converted serialized document.

31. The system for sharing a document between at least two document management units according to claim 20 wherein the second document management unit includes a database manager while the first document management unit includes a file manager for managing the first document in files and directories.

32. The system for sharing a document between at least two document management units according to claim 31 wherein the first document is represented by a predetermined set of the directories and the files, said first document management unit generating the serialized document based upon the directories and the files of the first document.

33. The system for sharing a document between at least two document management units according to claim 20 wherein the first document management unit includes a database manager while the second document management unit includes a file manager for managing the first document in files and directories.

34. The system for sharing a document between at least two document management units according to claim 33 wherein said second document management unit generating the files and the directories based upon the serialized document to represent the first document in said second document management unit.

35. The system for sharing a document between at least two document management units according to claim 34 wherein the first predetermined serialized format includes first document content and first property information, the second predetermined serialized format including second document content and second property information.

36. The system for sharing a document between at least two document management units according to claim 35 wherein said serialized document conversion unit adding a new piece of property information to the first property information according to the second property information.

37. The system for sharing a document between at least two document management units according to claim 35 wherein said serialized document conversion unit deleting a piece of property information from the first property information according to the second property information.

38. The system for sharing a document between at least two document management units according to claim 35 wherein said serialized document conversion unit converting a piece of the first property information to a corresponding piece of the second property information.

39. A storage medium for storing an interface program for document management modules, the interface program executing computer instructions to perform the following tasks of:
placing at least a first document in a first predetermined serialized format at a first document management module to generate a serialized document;
transferring the serialized document from the first document management module to a second document management module;
receiving the serialized document at the second document management module; and
converting the serialized document into a second predetermined format at the second document management module to generate a converted serialized document.

40. The storage medium for storing an interface program for document management modules according to claim 39 wherein the serialized document is processed at a processing module to generate a processed document subsequent to said transferring task.

41. The storage medium for storing an interface program for document management modules according to claim 39 wherein the serialized document is converted into files and directories prior to said transferring task and the files and the directories are processed prior to said transferring task to generate a processed document.

42. The storage medium for storing an interface program for document management modules according to claim 41 wherein the processed document is converted back to the serialized document in the first predetermined serialized format.

43. The storage medium for storing an interface program for document management modules according to claim 39 wherein the first predetermined serialized format includes first document content and first property information, the second predetermined serialized format including second document content and second property information.

44. The storage medium for storing an interface program for document management modules according to claim 43 wherein said converting task further includes an additional task of adding a new piece of property information to the first property information according to the second property information.

45. The storage medium for storing an interface program for document management modules according to claim 43 wherein said converting task further includes an additional task of deleting a piece of property information from the first property information according to the second property information.

46. The storage medium for storing an interface program for document management modules according to claim 43 wherein said converting task further includes an additional task of converting a piece of the first property information to a corresponding piece of the second property information.

47. The storage medium for storing an interface program for document management modules according to claim 39 wherein the serialized document is converted into files and directories prior to said transferring task and the files and the directories are processed at a remote location to generate a processed document, the processed document being converted back to the first predetermined serialized format and being transferred back to the first document management module.
